(19) United States
(12) Patent Application Publication
(10) Pub. No.: US 2025/0347787 A1
(43) Pub. Date: Nov. 13, 2025

(54) STATIC SELF-CALIBRATION FOR INDIRECT TIME-OF-FLIGHT CAMERAS

(71) Applicant: SEMICONDUCTOR COMPONENTS INDUSTRIES, LLC, Scottsdale, AZ (US)

(72) Inventors: Erez TADMOR, Atlit (IL); Guy LIKVER, Atlit (IL)

(73) Assignee: SEMICONDUCTOR COMPONENTS INDUSTRIES, LLC, Scottsdale, AZ (US)

(21) Appl. No.: 18/919,980

(22) Filed: Oct. 18, 2024

Related U.S. Application Data
(60) Provisional application No. 63/644,713, filed on May 9, 2024.

(51) Int. Cl. G01S 7/497; G01S 7/481; G01S 7/4911; G01S 7/4915; G01S 17/894; G06T 7/50; G06T 7/80; H04N 17/00; H04N 23/56; H04N 23/74

(52) U.S. Cl. CPC G01S 7/497; G01S 7/4816; G01S 7/4911; G01S 7/4915; G01S 17/894; G06T 7/50; G06T 7/80; H04N 17/002; H04N 23/56; H04N 23/74

(57) ABSTRACT

Systems, devices, and methods are described to statically calibrate a time-of-flight (TOF) imaging system requiring no movement during the calibration process and no external components. Methods may include placing a target at a set distance from the imaging system, delaying a modulation signal according to a distance offset, receiving a reflected light signal from the target, generating a pixel response based on the reflected light signal and modulation signal, calculating a distance-related value based on the pixel response, determining a correction value based on the distance-related value, and storing the correction value in a memory of the imaging system. The distance-related value may include a phase offset or a depth measurement. The method may be performed for a plurality of distance offsets and corresponding delays to generate a plurality of correction values that may be used when operating the imaging system to perform depth measurements.

### CROSS-REFERENCE TO RELATED APPLICATIONS

This application claims priority to U.S. Provisional Patent Application No. 63/644,713, filed May 9, 2024, and entitled “Calibration Method for Indirect-Time-of-Flight (iToF) Sensors,” the contents of which is hereby incorporated by reference in its entirety.

### BACKGROUND

iToF cameras may produce a modulated light signal that is sent into an environment and may include an image sensor adapted to receive the modulated light signal after it reflects from an object, also referred to as a target, in the environment. iToF cameras may include a laser driver or other light emitting device that is controlled to transmit light having a modulated illumination level. iToF cameras may further use the same modulation to control the response of the image sensor to the received modulated light, for example controlling the response of a pixel of the image sensor. The sensor response may be used to resolve the phase difference of the received modulated light, from which a distance to the target may be determined.

Many such camera systems may rely on a harmonic modulation of the illumination level and the pixel response to resolve the target phase and distance. The harmonic modulation of the light source, as well as the raw pixel response, is ideally a purely harmonic function. For example, the harmonic modulation may be a pure sin wave at some frequency. In real systems, however, the modulation of the light and/or the pixel response may include high-harmonic components which result in depth inaccuracies.

The distortion due to high harmonic components of the light modulation and/or pixel response can be corrected by determining the correct phase or depth for each value measured by the sensor. Such a calibration may be accomplished by placing a target at a series of known distances from the camera across the operation distance of the camera and comparing the measured sensor response to the expected response for each distance. However, calibrating the camera by physically moving either the camera or the target requires significant time per calibration and a large amount of space. Such a calibration process is expensive, increases the cost for the final product, and is not practical for high volume manufacturing.

It would therefore be desirable to provide improved systems and methods for calibrating an iToF camera.

### BRIEF DESCRIPTION OF DRAWING FIGURES

FIG. 1A is a graphic representation of ideal and non-ideal modulation signals, according to various embodiments.

FIG. 1B is a representatively illustrates a measurement error between ideal and non-ideal modulation signals, according to various embodiments.

FIG. 2 is a schematic diagram showing an exemplary iToF camera, according to various embodiments.

FIG. 3A representatively illustrates a measurement of depth information related to a target at a first distance, according to various embodiments.

FIG. 3B representatively illustrates a measurement of depth information related to a target at a second distance, according to various embodiments.

FIG. 4 is a flowchart for an illustrative method of calibrating an iToF imaging system, according to various embodiments.

FIG. 5 illustrates a response of an exemplary iToF imaging system before and after calibration, according to various embodiments.

FIG. 6 illustrates a response of an exemplary iToF imaging system having a pixel array arranged with column slices, according to various embodiments.

FIG. 7 illustrates a response of an exemplary iToF imaging system to a flat target, according to various embodiments.

### BRIEF SUMMARY

Various embodiments relate to systems, devices, and methods to automatically calibrate an iToF camera without moving the target or the camera.

In various embodiments, a method for calibrating an indirect time-of-flight (iToF) imaging system using a target at a set distance from the iToF imaging system may include applying, by a camera module of the iToF imaging system, a delay to at least one selected from the group of an illumination modulation signal and a pixel modulation signal, wherein the delay corresponds to a distance offset from the set distance; transmitting, by the iToF imaging system, a light signal according to the illumination modulation signal; receiving, at a pixel array of the camera module, a reflected signal comprising the light signal reflected from the target; generating, by the pixel array, a pixel response based the reflected signal and the pixel modulation signal; calculating, by the camera module, a distance-related value based on the pixel response; determining, by the camera module, a correction value based on a difference between the calculated distance-related value and an expected distance-related value due to the applied delay; and storing, in a memory of the camera module, the correction value associated with the distance-related value.

In various embodiments, an indirect time-of-flight (iToF) imaging system may include a modulation delay generator configured to generate a pixel modulation signal having a delay; a pixel array configured to output a pixel response signal; a modulation controller configured to control the pixel array according to the pixel modulation signal; a phase calculation circuitry configured to calculate a correction value based on the pixel response signal; and a memory storing a look-up table for correction values.

In various embodiments, a method for calibrating an indirect time-of-flight (iToF) imaging system using a target at a set distance from the iToF imaging system may include receiving, by a sensor module of the iToF imaging system, a light signal from the target; generating, by the sensor module, a plurality of pixel responses based on the received light signal and a plurality of pixel modulation signals, wherein each of the plurality of pixel modulation signals is delayed by an amount equal to a plurality of distance offsets from the set distance; calculating, by the sensor module, a plurality of distance-related values based on the plurality of generated pixel responses; determining, by the sensor module, a plurality of correction values corresponding to the plurality of calculated distance-related values; storing, in a memory of the sensor module, the plurality of correction values associated with the plurality of calculated distance-related values; and validating, by the iToF imaging system, the plurality of correction values.

These and other examples are described in increasing detail below.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, iToF imaging systems and methods are used to calibrate an iToF camera and provide correction to measurements taken by an iToF camera. Various embodiments may correct for distortion due to high harmonic components using a memory, such as look-up-table (LUT), that assigns the correct phase or depth for each value measured by the camera. Some methods of calibrating the LUT may measure a series of known target distances and create a table that assigns a correction value for each known distance. Advantageously, according to various embodiments described herein, calibrating the LUT may be done without physically moving either the iToF camera or the target, saving significant time and cost per calibration.

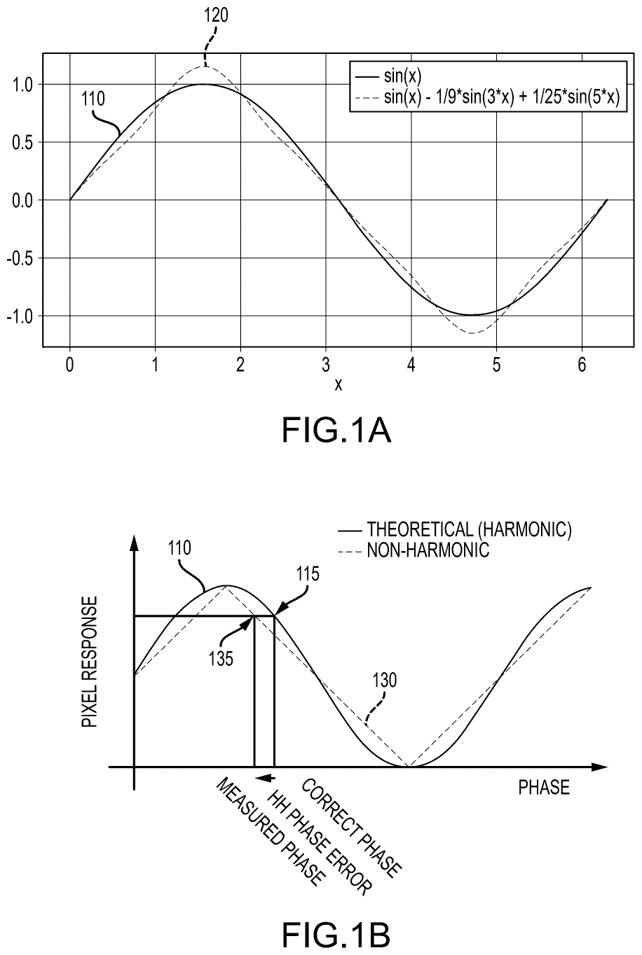

Referring to FIG. 1A, some iToF sensors and cameras may rely on harmonic modulation of the illumination level and of the pixel response to resolve the phase change of light returning from a target and therefore the distance to the target. For example, iToF systems may assume that an illumination source is modulated (e.g., amplitude modulated) as a sine wave, and the pixel(s) receiving the reflected light is modulated with a sine wave. The raw pixel response vs. target distance is ideally a pure harmonic function, following the equation:

$${Q}_{ideal} = A sin ( Δφ ) + {C}_{1} \qquad ( Eq . 1 )$$

In equation 1 (Eq. 1), Δφ is the phase offset correlated to the target distance from the iToF system and A is the amplitude of the light from the illumination source. The variable C₁ is the pixel response component due to the sum of all non-modulated signal sources, for example natural or artificial ambient illumination, dark current, analog and digital signal biases and offsets, and the like. The variable C₁ also indicates that, in some embodiments, the pixel response cannot be less than zero and therefore cannot be described solely by a pure sine function. The ideal pixel response (ignoring the effects of the variable C₁) is plotted as line 110.

However, in many iToF systems, the modulation of the illumination source (also referred to as a light source) and/or the pixel's response to the received light may not be ideal and may include high harmonic or other components. In some such systems, the illumination source and the pixel may be modulated with a signal that more closely resembles a square wave, for example due to imperfect reproduction of a sine wave. Convolving the square wave-like received illumination and the square wave-like pixel modulation results in a pixel response that more closely resembles a triangular wave. An exemplary realistic pixel response is plotted as line 120, for example showing higher harmonic components.

Referring to FIG. 1B, the ideal pixel response 110 is plotted along with an exemplary non-harmonic pixel response 130. For a given pixel response, the difference between the measured phase 135 and the ideal (“correct”) phase 115 results in a phase error for that pixel response. The ideal phase 115 for a given pixel response is based on the harmonic modulation and target distance, given ideal harmonic modulation of the light source and/or pixel.

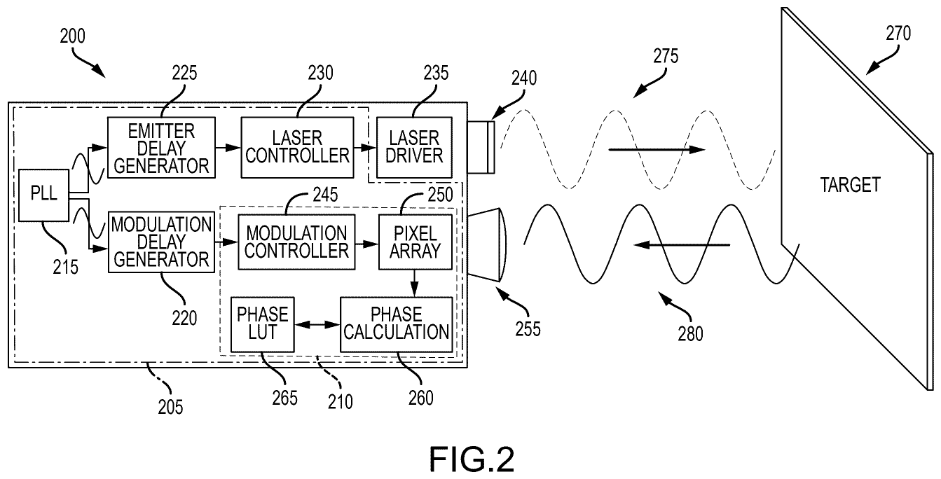

FIG. 2 representatively illustrates an exemplary imaging system 200 configured to perform indirect Time-of-Flight measurement. The imaging system 200 may be a stand-alone camera, including in a cellular telephone, computer, video camera, surveillance system, automotive imaging system, video game system, augmented and/or virtual reality system, unmanned aerial vehicle system, or any other desired imaging system tor device that captures image data and determines information about one or more targets in the imaged environment. The imaging system 200 may also be referred to as an iToF system.

The imaging system 200 may include a camera module 205, an emitter 240, and a lens system 255. The emitter 240 may be configured to emit light for illuminating an image scene, for example one or more targets in an environment. The emitter 240 may be a laser emitter or other source of light controllable to transmit light 275 toward a target. In some embodiments, the emitter 240 may include a laser diode or the like. The lens system 255 may comprise any suitable system adapted to receive light 280 from the emitter 240 after it is reflected from a target 270 and to focus the received light 280 on a sensor module 210 of the camera module 205. In some embodiments, for example during calibration, the target 270 may be flat. The imaging system 200 may be arranged such that the image plane of the camera module 205 is parallel with the flat target 270, which may include arranging the imaging system 200 orthogonal to the surface of the flat target 270.

In some embodiments, the camera module 205 may include hardware and/or software adapted to control the emitter 240 and the sensor module 210. For example, the camera module 205 may include a phase-locked-loop (PLL) 215 or other signal generator that generates an oscillating signal, such as a square wave, sine wave, or other suitable periodic signal at a selected frequency. The periodic PLL 215 signal, which may also be referred to as a modulation signal, may be provided to a laser controller 230 of the camera module 205, which may be adapted to drive the emitter 240 via a laser driver 235 based on the signal from the PLL 215 to produce the modulated transmitted light 275. The PLL 215 modulation signal provided to the laser controller 230 may be referred to as the illumination modulation signal. The modulated transmitted light 275 may have a modulated amplitude and may be at a modulation frequency. In some embodiments, the emitter 240 and/or the laser driver 235 may be external to the camera module 205.

The PLL 215 modulation signal may also be provided to the sensor module 210 for modulation of a pixel array 250. The PLL 215 modulation signal provided to the sensor module 210 may be referred to as the pixel modulation signal. The pixel modulation signal and the illumination modulation signal from the PLL 215 are shown as sine waves in FIG. 2 for illustrative purposes. In some embodiments, the PLL 215 may provide the modulation signals as a digital signal, for example a square wave with a 50% duty cycle at the modulation frequency and in a specific phase. In some embodiments, the modulation signals may be generated external to the camera module 205 and/or sensor module 210, for example supplied through a dedication input/output (IO) pin.

The camera module 205 may be used to convert incoming light into digital image data, for example using one or more sensor modules 210. During image capture processes, light from a scene, for example light reflected from a target in the imaged environment, may be focused onto the sensor module 210 by the lens system 255 and/or microlenses of the sensor module 210. The sensor module 210 may include circuitry for generating analog pixel image signals and circuitry for converting analog pixel image signals into corresponding digital image data. The digital image data may be provided to storage and/or processing circuitry included in the sensor module 210, camera module 205, imaging system 200, and/or otherwise communicatively coupled with the imaging system 200.

The storage and/or processing circuitry may include one or more integrated circuits, such as image processing circuits, microprocessors, storage devices such as random-access memory, non-volatile memory such as one-time programmable fuses, and/or the like. The storage and/or processing circuitry may be implemented using components that are part of the camera module 205 and/or that are separate from the camera module 205. Various stacking, system-on-chip, and/or other arrangements of the various components of the camera module 205 may be suitably used. Image data that has been captured by the sensor module 210 may be processed and stored using the storage and/or processing circuitry. Processed image data, for example distance or other target information, may be provided to external equipment such as an external system, computer, device, or the like using wired and/or wireless communication paths coupled with the camera module 205 and/or imaging system 200.

The storage and/or processing circuitry may include phase calculation circuitry 260 configured to determine phase of the received light 280 from the target 270. The phase calculation circuitry 260 may be implemented in hardware and/or software, for example implemented using an image signal processor of the camera module 205. The phase calculation circuitry 260 may further determine a distance to the target 270 based on the determined phase.

In some embodiments, the storage and/or processing circuitry may include a look-up table (LUT) 265. The LUT 265 may include or may be stored in a memory, and may be configured to store one or more corrected phase values (or other correction factor) corresponding to one or more measured phases. The LUT 265 may be operable to provide a correction to the determined (or measured) phase, for example during a non-calibration measurement operation of the imaging system 200. The phase calculation circuitry 260 may use the correction or corrected phase value from the LUT 265 to determine a more accurate phase and therefore distance to the target 270. The LUT 265 may, for example, be implemented using one-time programmable memory, such as fuses. In some embodiments, the LUT 265 and phase calculation circuitry 260 may be implemented as part of the sensor module 210.

The phase calculation circuitry 260 may use the correction or corrected phase value obtained from the LUT 265 to determine a more accurate phase and therefore distance to an object when the imaging system 200 is operating during normal use, for example measuring the depth to the object in an environment post-calibration. In some embodiments, the phase calculation circuitry 260 may be configured to, during a non-calibration operation, determine a corrected depth value for an object measured by the imaging system 200. The phase calculation circuitry 260 may, for example, be configured to retrieve the appropriate correction value from the LUT 265 based on the measured phase and/or distance, and apply the retrieved correction value to the measured phase and/or distance to generate the corrected depth value. The sensor module 210, camera module 205, and/or imaging system 200 may output the corrected depth value.

As described above, the sensor module 210 may be configured to gather the reflected emitted light and to generate ToF information for the image scene, such as distance information to one or more targets, a depth map of the image scene, an image of the image scene, and/or other information related to ToF imaging. A target may be any object in the image scene, and more than one target or object may exist in the image scene. The sensor module 210 may include other elements such as microlenses, color filter arrays, and other circuitry suitable for providing desired image sensing functionality.

The sensor module 210 may include an image sensor, such as a complementary metal-oxide-semiconductor (CMOS) image sensor or other suitable photosensitive device technology. The sensor module 210 may include a pixel array 250 containing sensor pixels arranged in rows and columns (not shown) and controlled by control circuitry. In general, any suitable configuration for a lock-in pixel or any other suitable types of (indirect) ToF sensing pixels may be used.

The arrangement of the pixels, pixel array, and control circuitry may be the same as or similar to U.S. Pat. No. 11,943,553, which is incorporated herein by reference. The pixel array 250 may include tens, hundreds, or thousands of rows and columns of sensor pixels. The control circuitry may include pixel driver circuitry to perform sensing and pixel selection operations, and may include readout circuitry to perform readout operations from the sensor pixels. In some embodiments, the pixel driver circuitry may include row control circuitry, and the readout circuitry may include column readout and control circuitry.

In some embodiments, the sensor pixels may be operable to store photon-generated charge in one or more storage regions based on the modulation signal from the PLL 215, and may be operable to readout the separately stored charge portions for performance of phase determination and/or other ToF functionality. For example, each sensor pixel may include one or more modulation control transistors as described with respect to U.S. Pat. No. 11,943,553, as referenced above. The sensor module 210 may include a modulation controller 245, which may include circuitry and/or software configured to generate control signals for each pixel based on the modulation signal from the PLL 215. The generated control signals may be configured to appropriately drive the sensor pixels to generate the corresponding charge portions according to the modulation signal, for example controlling the gates of the one or more modulation control transistors.

In some ToF configurations, the sensor module 210 may use one or more pixels in the pixel array 250 to gather multiple image signals corresponding to a set of image frames to perform an iToF sensing operation. For example, each sensor pixel may generate charge in response to the incident received light 280 at different phases and/or different frequencies. The different phases and/or frequencies may be controlled according to the PLL 215 modulation signal, and may include the modulated light source as controlled by the laser controller 230 and/or laser driver 235, and/or the sensor module 210 modulation as controlled by the modulation controller 245. The output of the pixel array 250 in response to the charge generated by one or more pixels may be referred to as the pixel response signal.

The generated charge for each pixel is readout to construct the corresponding image frames associated with the different phases and/or different frequencies. The phase calculation circuitry 260 may process the image frames associated with the different phases and/or different frequencies to determine the ToF information such as object depth or distance information for the scene. This determination may be based on the phase difference between the light signal transmitted by the emitter 240 and the reflected light signal sensed by the pixel array 250.

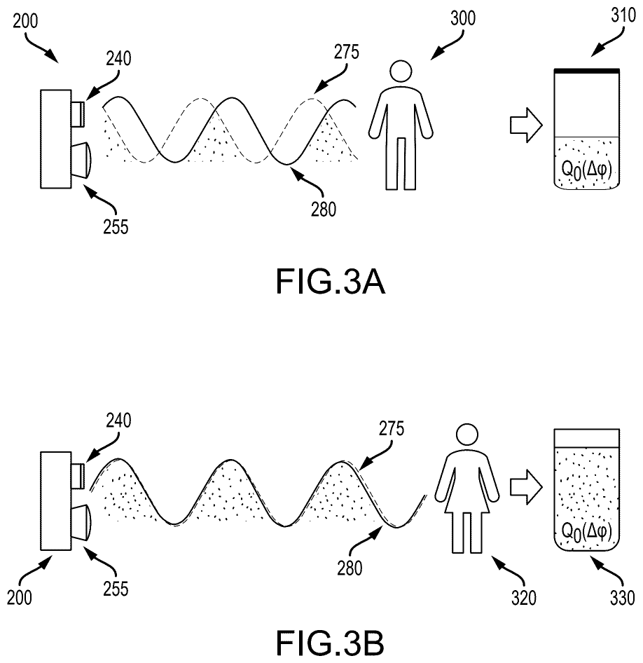

FIGS. 3A and 3B representatively illustrate iToF measurements of depth information related to a target based on a phase offset of the modulated transmitted light 275 and received light 280. In an iToF camera, the input and reference signals are the modulated light signals, for example laser pulses, and the modulated pixel response, respectively. As discussed above, in some embodiments the imaging system 200 transmits the modulated light that can be approximated to the first order as a harmonic signal. For example, the magnitude of the transmitted light 275 (e.g., laser) signal may be:

$${L}_{TX} = \frac{A}{2} [ sin ( 2 π {f}_{m} t ) + {C}_{2} ] \qquad ( Eq . 2 )$$

In Eq. 2, A is the laser amplitude and fₘ is the modulation frequency, for example determined according to the modulation signal from the PLL 215. Here, the variable C₂ indicates that the light intensity cannot be less than zero and therefore cannot be described solely by a pure sine function. As the laser is reflected from the target, a phase offset Δφ (also referred to as a phase difference) that is correlated to the target distance may be introduced. For example, the equation for the magnitude of the received light 280 signal reflected from the target may be:

$${L}_{RX} = \frac{ρ A}{2} [ sin ( 2 π {f}_{m} t - Δφ ) + {C}_{2} ] \qquad ( Eq . 3 )$$

In Eq. 3, p is the target reflectance. Referring to FIG. 3A, a first target 300 may be at a first distance from the imaging system 200, which may result in the received light 280 having a first phase offset Δφ compared to the transmitted light 275. Referring to FIG. 3B, a second target 320 may be at a second distance from the imaging system 200, which may result in the received light 280 having a second phase offset Δφ compared to the transmitted light 275. As illustrated, the first phase offset Δφ is approximately one-third of a cycle, or ⅔π radians, and the second phase offset Δφ is almost zero.

The returning light (laser) signal may be collected in one or more sensor pixels of the pixel array 250. Each pixel response may be modulated with the same modulation frequency as the laser. For example, the equation for the magnitude of the pixel signal may be:

$${R}_{pix} = \frac{{c}_{m}}{2} [ sin ( 2 π {f}_{m} t + {Φ}_{0} ) + {C}_{1} ] \qquad ( Eq . 4 )$$

In Eq. 4, cₘ is the pixel modulation contrast, and Φ₀ is an arbitrary phase between the laser modulation and the sensor modulation due to electronic propagation of the PLL 215 modulation signal. In some embodiments, the PLL 215 modulation signal may be provided to both modulate the laser signal and modulate the pixel response. The electronic propagation of the PLL 215 modulation signal to the laser controller 230, laser driver 235, and emitter 240 may require a different amount of time compared to the electronic propagation of the PLL 215 modulation signal to the modulation controller 245 and pixel array 250. The arbitrary phase Φ₀ may be determined and accounted for when calibrating the imaging system 200 and may be constant.

For example, referring again to FIG. 2, in some embodiments the camera module 205 may include an emitter delay generator 225 and/or a modulation delay generator 220. Each of the emitter delay generator 225 and modulation delay generator 220 may be configured to controllably delay the modulation signal from the PLL 215 to illumination source and the modulation controller 245 of the sensor module 210, respectively. For example, the emitter delay generator 225 may be coupled between the PLL 215 and the laser controller 230, and the modulation delay generator 220 may be coupled between the PLL 215 and the modulation controller 245. In some embodiments, the modulation delay generator 220 may be included in the sensor module 210.

In some embodiments, the periodic modulation signal may be directly generated by the PLL 215 and then delayed as desired by the emitter delay generator 225 and/or modulation delay generator 220. In some embodiments, the PLL 215 may output a baseline modulation signal, such as a square wave, clock signal, or the like, which may be manipulated by one or more of the emitter delay generator 225, modulation delay generator 220, laser controller 230, and/or modulation controller 245 to create the periodic modulation signal that is the illumination modulation signal and/or the pixel modulation signal.

In some embodiments, modulation signal from the PLL 215 may be manipulated by the emitter delay generator 225 and/or modulation delay generator 220, which may for example change the duty cycle of the modulation signal, change the pattern of the modulation signal, divide the frequency of the modulation signal, and/or the like. In some embodiments, the output of the modulation controller may still be a digital signal, such as a square wave. In some such embodiments, the transformation of the square wave into a harmonic function may be done in the analog and optical domain. For example, analog transmission functions may act as a low-pass filter, turning the square wave into a more harmonic shape in the analog domain. For further example, the multiplication of the laser pulse shape and the pixel modulation pulse shape may also generate a more harmonic shape if tuned correctly.

In some embodiments, each of the delay generators may include a duty cycle adjuster configured to generate a delay in the received PLL 215 modulation signal. In some embodiments, the camera module 205 may be configured to account for the arbitrary phase Φ₀ by controlling the emitter delay generator 225 and/or modulation delay generator 220 to offset the determined arbitrary phase Φ₀ by delaying the appropriate modulation signal.

The collection of the modulated returning light in the modulated pixel may act as a mixer and low pass filter, for example for a lock-in pixel. For example, the two signals may be mixed and integrated over the duration of the sensor exposure time. The equation for the total value integrated over the exposure time may be:

$${Q}_{0} = \frac{1}{{T}_{int}} {\int }_{0}^{{T}_{int}} \frac{ρ A}{2} [ sin ( 2 π {f}_{m} t - Δφ ) + {C}_{2} ] \cdot \frac{{c}_{m}}{2} [ sin ( 2 π {f}_{m} t + {Φ}_{0} ) + {C}_{1} ] dt \qquad ( Eq . 5 )$$

Solving Eq. 5, all transient (time dependent) factors disappear, which results in the following expression for the signal integrated by the pixel:

$${Q}_{0} = \frac{{A}^{′} {c}_{m}}{2} [ cos ( Δφ + {Φ}_{0} ) + C ] \qquad ( Eq . 6 )$$

In Eq. 6, the factor A′ contains the dependence of pixel output on integration time, laser power, and the like. The variable C accounts for both C₁ and C₂. Notably, Eq. 6 shows a non-transient response that depends on the phase offset Δφ, and therefore depends on the target distance. Referring again to FIGS. 3A and 3B, the shaded area under the overlapping transmitted light 275 and received light 280 signals represents a value integrated by the modulated sensor pixel, which changes depending on the phase offset. For example, the first response 310 Q₀ of the pixel to the first target 300 results in a value that differs from the second response 330 Q₀ of the pixel to the second target 320, wherein the value is correlated to the distance of the target according to the phase offset Δφ.

It may be beneficial to remove all factors and dependencies other than the phase offset itself when measuring the target distance using iToF systems and methods. In some embodiments, this may be achieved by taking multiple exposures using different phases between the laser modulation and pixel array 250 modulation. Phase differences may be added and/or subtracted from the modulation signals provided to the illumination source and/or the sensor module 210 for this purpose.

In some embodiments, the emitter delay generator 225 and/or modulation delay generator 220 may be controlled to push forward or pull back the modulation signal from the PLL 215 in any suitable combination to achieve the desired phase difference between the illumination modulation and the pixel array 250 modulation for each of the multiple exposures. For example, the emitter delay generator 225 may be controlled to not apply a delay to the modulation signal from the PLL 215, and the modulation delay generator 220 may be controlled to apply the desired phase difference as a delay to the modulation signal to the modulation controller 245. For further example, the emitter delay generator 225 may be controlled to apply the desired phase difference as a delay to the modulation signal from the PLL 215 to the laser controller 230, and the modulation delay generator 220 may be controlled to not delay the modulation signal.

In some embodiments, the imaging system 200 may be configured such that it is capable of outputting a positive half-cycle of the periodic modulated transmitted light 275, but not capable of outputting the negative half-cycle. Determining a full cycle response may include outputting two half-cycles 180 degrees apart. Removing all factors and dependencies other than the phase offset itself may include taking four exposures with each exposure having an additional phase Φ between the laser modulation and pixel array 250 modulation, for example Φ=0°, 90°, 180°, 270°, respectively. The additional phase Φ is the phase difference for different exposures as described above. The additional phase Φ may be applied in addition to the determined and accounted-for arbitrary phase Φ₀. The resulting equations for the four different pixel response signals from the four exposures are:

$$\begin{matrix}{Q}_{1} = A sin ( Δφ ) + C & \{ Φ = 0 ° \}\end{matrix} \qquad ( Eq . 7 )$$

$$\begin{matrix}{Q}_{2} = A cos ( Δφ ) + C & \{ Φ = 90 ° \}\end{matrix} \qquad ( Eq . 8 )$$

$$\begin{matrix}{Q}_{3} = - A sin ( Δφ ) + C & \{ Φ = 180 ° \}\end{matrix} \qquad ( Eq . 9 )$$

$$\begin{matrix}{Q}_{4} = - A cos ( Δφ ) + C & \{ Φ = 270 ° \}\end{matrix} \qquad ( Eq . 10 )$$

The phase offset can then be calculated from:

$$Δφ = a tan ( \frac{{Q}_{1} - {Q}_{3}}{{Q}_{2} - {Q}_{4}} ) \qquad ( Eq . 11 )$$

The mathematical operation between the four exposures and pixel responses removes all non-time dependent biases such as ambient light or pixel dark current, as well as factors such as target reflectance, laser power, pixel responsivity, and the like. The resulting determined depth measurement, based on the determined phase offset, is:

$$D = \frac{C}{2} \cdot \frac{Δφ}{2 π {f}_{m}} \qquad ( Eq . 12 )$$

In some embodiments, the method of determining a depth measurement described above with respect to equations 2-12 may be done for each pixel in the pixel array 250. The method described above performs as expected if the illumination L_{TX} and pixel modulation are both first order harmonic functions, and therefore the pixel response versus phase Q₁, Q₂, Q₃, Q₄ are also first order harmonic functions.

However, in some iToF systems, the shape of the pixel modulation and/or illumination modulation may be distorted and not perfectly harmonic. In such systems, the pixel response may also be distorted. These distortions may be described using higher harmonics in a Fourier series and are therefore often referred to as high-harmonic distortion. This high-harmonic distortion may introduce the phase (and therefore depth) measurement error to the imaging system 200 described above. The imaging system 200 may be calibrated to account for the distortion, with the calibration values stored in the LUT 265 or other memory to convert the distorted phase and/or depth value to a corrected value.

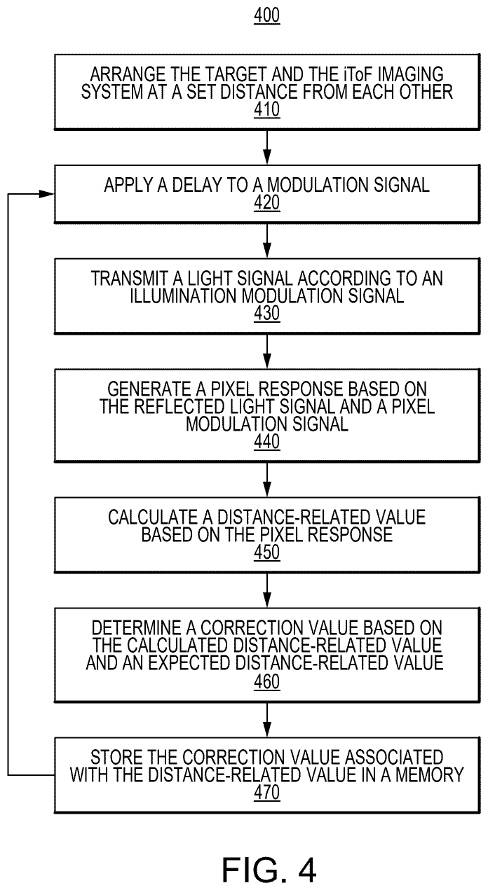

FIG. 4 representatively illustrates an exemplary method 400 for calibrating an iToF imaging system 200. The calibration method 400 may calculate the error for a given delay added to the pixel modulation signal and/or illumination modulation signal and may associate it with the correct value for the given delay.

The calibration method 400 may include a step 410 of arranging the imaging system 200 and a target 270 at a set distance from each other. In some embodiments, the target 270 may include a flat surface from which the light source will reflect, or another shape suitable for performing the calibration. The set distance may be set to any suitable value, for example accounting for the wavelength of transmitted light on which the imaging system 200 operates, the space available for calibration operations, and/or the like. Advantageously, the entire calibration method 400 may be performed without moving the imaging system 200 or the target 270, and may be performed without the use of external systems or components to assist the calibration.

At step 420, the imaging system 200 may apply a delay to the pixel modulation signal and/or illumination modulation signal. In some embodiments, the emitter delay generator 225 and/or modulation delay generator 220 may apply the delay as appropriate. For example, the delay may be applied only to the pixel modulation signal, only to the illumination modulation signal, or may be some combination of delays may be applied to both the pixel modulation signal and illumination modulation signal to arrive at the chosen delay.

The applied delay is therefore the overall delay chosen between the pixel modulation signal and the illumination modulation signal, not including the accounted-for arbitrary phase Φ₀ or the additional phases Φ used for taking multiple exposures as described above. The applied delay corresponds to a phase offset and therefore distance offset (in the positive or negative direction) from the actual location of the target 270, and therefore corresponds to a distance other than the set distance unless the applied delay is set to zero. The applied delay may be used to emulate the effect of changing the distance between the imaging system 200 and the target 270 by the distance offset corresponding to the applied delay, without physically moving either device.

At step 430, the imaging system 200 may transmit the light signal from the emitter 240 according to the illumination modulation signal, as described above. If the delay of step 420 is applied to the illumination modulation signal, then the light signal will be delayed by a corresponding amount.

At step 440, the pixel array 250 may receive the light signal after it has reflected from the target 270. The reflected signal may be received by one or more pixels of the pixel array 250. At step 440, the sensor module 210 may also generate a pixel response based on the received reflected signal and the pixel modulation signal, for example as controlled by the modulation controller 245. In some embodiments, the pixel response may be generated as discussed above with respect to the pixel response Q₀ of equation 6, with response to the pixel responses Q₁, Q₂, Q₃, Q₄of equations 7-10, or any other suitable pixel response methods and calculations.

At step 450, the imaging system 200 may calculate a distance-related value based on the generated pixel response. In some embodiments, the distance-related value may be calculated by the camera module 205, for example by the sensor module 210, such as using the phase calculation circuitry 260. In some embodiments, the distance-related value may be the calculated phase offset Δφ, for example calculated according to equation 11. In some embodiments, the distance-related value may be the determined depth measurement D, for example calculated according to equation 12. Due to imperfect modulation of the illumination signal and/or pixel response, the calculated distance-related value will likely be different than the expected distance-related value based on the applied delay.

At step 460, the imaging system 200 may determine a correction value based on the calculated distance-related value and the expected distance-related value. The expected distance-related value may be the ideal (or correct) distance-related value based on the applied delay from step 420. The correction value may be the error, or difference, between the calculated distance-related value and the expected distance-related value. For example, the correction value may be added, or subtracted as appropriate, to the calculated distance-related value to obtain the ideal distance-related value.

In some embodiments, the correction value may be determined by the camera module 205, for example by the sensor module 210, such as using the phase calculation circuitry 260. In some embodiments, the correction value may be determined by determining the difference between the calculated distance-related value and the expected distance-related value. The difference may comprise the amount to add or subtract from the calculated distance-related value to obtain the expected distance-related value. In some embodiments, the correction value may be phase information or distance information. For example, the sensor module 210 may determine a correction value usable to obtain the expected phase offset or expected determined depth measurement from the calculated phase offset or calculated determined depth measurement, respectively.

At step 470, the correction value may be associated with the calculated distance-related value in a memory of the camera module 205, for example in a memory of the sensor module 210, such as the LUT 265. In some embodiments, the correction value itself may be stored, for example by the sensor module 210, in the memory such that it is retrievable according to the calculated distance-related value. For example, an entry of the LUT 265 may associate the calculated distance-related value with the corresponding correction value. In some such embodiments, the correction value may be retrievable from the memory and usable to determine a corrected phase offset or a corrected depth measurement. The corrected phase offset and corrected depth measurement may be referred to as the calibrated phase offset and calibrated depth measurement, respectively.

Alternatively or additionally, at step 470, the expected (correct) phase offset or expected (correct) determined depth measurement may be stored, for example by the sensor module 210, in the memory such that it is retrievable according to the calculated distance-related value. For example, an entry of the LUT 265 may associate the calculated distance-related value with the corresponding expected distance-related value. In some such embodiments, the expected distance-related value may be the expected phase offset and may be retrievable from the memory for direct use as the calibrated phase offset. In other such embodiments, the expected distance-related value may be the expected depth measurement and may be retrievable from the memory for direct use as the calibrated depth measurement. It will be recognized that one may select one or more of the determined phase offset, the resulting determined distance offset, the corrected phase, and/or the corrected distance for use in various alternative embodiments of the calibration method 400, as well as for actual depth measurement operations of the imaging system 200.

The methods steps 420 to 470 may be repeated for a plurality of different applied delays to determine a plurality of associated correction values that can be stored in the memory. In some embodiments, repeating the method steps 420 to 470 may include a repetition where the applied delay is equal to zero to perform calibration for the set (actual) distance between the imaging system 200 and target 270. Alternatively or additionally, a repetition may skip step 420 such that a delay is not applied, also resulting in calibration for the set distance.

The plurality of applied delays may be effective to emulate scanning the pixel response for different distances between the imaging system 200 and target 270 to extract the high harmonic and/or other distortion, without having to physically change the distance between the imaging system 200 and target 270. Accordingly, the imaging system 200 can be accurately calibrated across its entire range of depth sensing without moving it or the target 270.

The calibration method 400 may be done for one or more pixels, rows, columns, slices, or other arrangements of the pixels in the pixel array 250 to generate the correction values for the LUT 265. In some embodiments, the calibration method 400 may be performed for a subset or all pixels of the pixel array 250, and the results may be averaged to determine the values placed in the LUT 265 such that the correction values/corrected values are applied to the entire array.

Advantageously, during operation of the calibrated imaging system 200, for example during a non-calibration depth measurement for measuring a distance to an object in image scene, the camera module 205 and/or sensor module 210 may directly output the corrected depth value corresponding to the object and additional and/or external correction is not required.

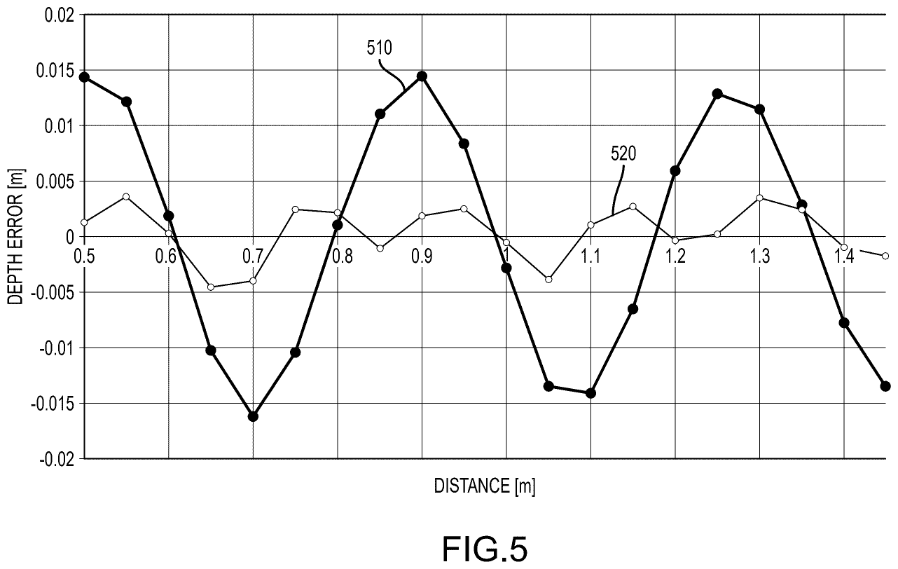

FIG. 5 representatively illustrates the response of an exemplary iToF imaging system 200 both before and after calibration according to the calibration method 400. The horizontal axis represents the distance between a target and the imaging system 200, and the vertical axis represents the depth error for a given target distance. Line 510 illustrates the depth error of a target measured by the imaging system 200 before calibration for a distance of 1 meter +/−0.5 meters, measured at 0.05 meter intervals. The depth error for the exemplary imaging system 200 ranges from about +15 mm to about −15 mm. Line 520 illustrates the depth error of the same target at the same positions after calibration. The depth error for the exemplary imaging system 200 post-calibration ranges from about +5 mm to about −5 mm, showing a three-fold improvement in measurement error.

In some embodiments, the pixel array 250 may be arranged into groups of pixel rows and/or columns referred to as “slices.” The configuration of the groups of columns into slices may be the same as or similar to U.S. Pat. No. 11,943,553, which was incorporated and discussed above. Each slice may be driven in constant delay with respect to adjacent slices. For example, each subsequent slice may integrate the received reflected light according to a pixel modulation signal having a constant added delay compared to the prior slice. In some embodiments, the modulation delay generator 220 may apply the constant additional delay for each subsequent slice.

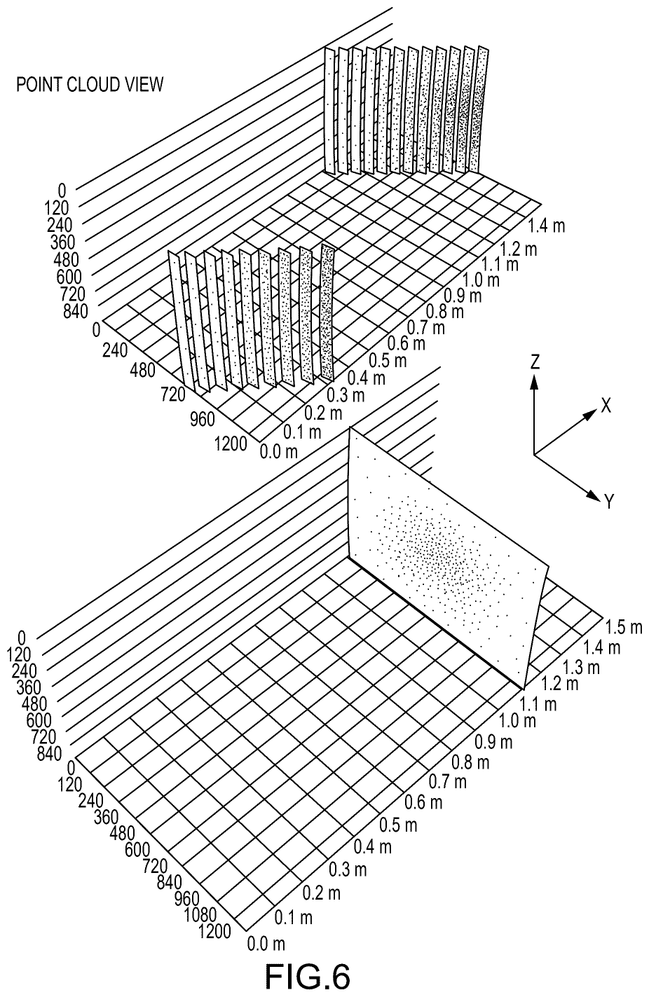

FIG. 6 illustrates a response of an imaging system 200 to a flat target, wherein the pixel array 250 is arranged into slices where each slice is modulated with a modulation signal having a constant delay from the prior column. In FIG. 6, the depth measured is plotted along the X-axis, the width measured is along the Y-axis, and the height measured is along the Z-axis. Before correction, each slice has a different measured depth based on the constant added delay, from about 0 meters to about 1.5 meters. In addition, each slice suffers from the same high harmonic distortion described above.

The raw (before correction) output may be corrected by shifting the slice depth value by the known constant delay that was introduced for each slice. In some embodiments, the calibration method 400 may further include correcting the raw output by shifting the slice depth value by the known constant delay, before or after correcting for the high harmonic distortion. The constant delay may be considered the same as an additional arbitrary phase Po and may be accounted for in a similar manner.

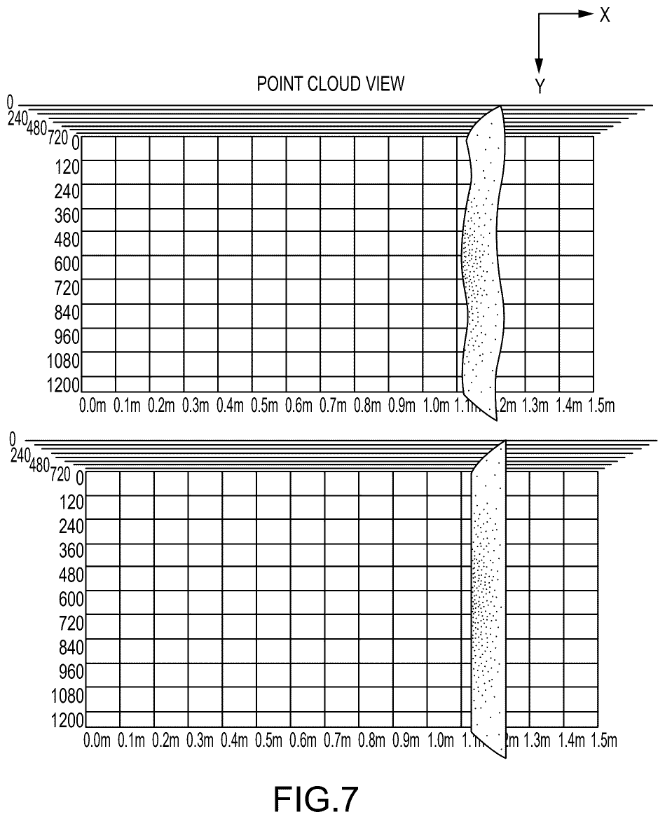

For example, the substantially flat after-correction response shown by FIG. 6 may be obtained by first calibrating for high harmonic distortion and then shifting the slice depth values by the constant delays. Referring to FIG. 7, which also illustrates a response of the imaging system 200 to the flat target, the before-correction response may be obtained by first shifting the slice depth values by the constant delays, resulting in a wavy response that includes the high harmonic distortion. In FIG. 7, the depth measured is plotted along the X-axis, the width measured is along the Y-axis, and the height measured is along the Z-axis which is the direction coming out of the surface of the drawing. The calibration method 400 may then proceed to calibrate the imaging system 200 for the high harmonic distortion as described above, resulting in the substantially flat after-correction response shown in FIG. 7.

Because high harmonic distortion may be phase dependent, each slice may exhibit a separate high harmonic response. The additional use of pixel array 250 slices may therefore improve the high harmonic calibration. The correction determined for a given slice may be used for the entire array. In some examples, the correction for all slices may be averaged to obtain the correction values that can be applied to the entire pixel array 250. The use of pixel array 250 slices may also be used to validate the quality of the calibration obtained by the calibration method 400.

In some embodiments, the calibration method 400 may include the steps, after determining all correction values, of performing a depth measurement of a known target, including application of the calibration, and then validating the quality of the calibration. For example, the target may comprise a flat target, such as the target used for determining the correction values. Validating the quality of the calibration may include determining if the calibrated response of the imaging system 200 to the flat target has a flatness below a threshold. If the flatness is below the threshold, then the calibration may be validated.

The threshold may be based on the wavelength(s) used by the imaging system 200 to measure the target, based on the sensing range of the imaging system 200, based on design goals, and/or other suitable criteria. For example, the threshold may be a target flatness of less than 0.01 mm, 0.1 mm, 1 mm, 5 mm, 10 mm, 15 mm, 20 mm, or the like for a sensing range of about zero meters to about five meters. For further example, the target flatness may also be a predetermined percentage of the relevant wavelength(s).

Various embodiments therefore provide systems, devices, and methods that can statically calibrate an iToF camera using a target set at a fixed distance from the iToF camera. The imaging system 200, for example in the camera module 205 and/or sensor module 210, may include hardware and/or software to perform iToF calibration and determine distances to one or more targets. Various embodiments may include adding a phase delay to a pixel modulation signal and/or an illumination modulation signal, determining a correction value based on a phase or other output of the sensor module 210, a phase and/or depth correction in a LUT of the sensor module 210. During a post-calibration iToF measurement, the output of the sensor module 210 may include the corrected depth.

Advantageously, all systems and devices, other than the target, are integrated into the camera system 200 itself, for example in the camera module 205 and/or sensor module 210. This allows for a self-contained solution that can be easily used during a manufacturing process, assembly process, and/or in the field. In contrast, prior methods of calibrating an iToF camera required moving the camera and/or target for each of the calibrated distances, requiring increased time and cost to perform. Further, such prior methods did not provide for reliable calibration in the field.

The various components and functions shown and described in the process flows and iToF camera may be distributed amongst the various components of the imaging system 200 in any manner, and different embodiments may organize the processing of various features and information in any number of different ways. Several of the various features and systems described herein may be implemented in software and/or firmware that resides in non-transitory data storage for execution by one or more processors to perform the various (automated) processes described herein.

It will be recognized that circuitry described herein may alternatively or additionally be implemented as computer instructions (software, firmware, or the like) configured to cause a processor to perform the functions of the described circuitry. It will also be recognized that computer instructions described herein may alternatively or additionally be implemented as hardware circuitry operable to perform the functions of the described computer instructions.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A method for calibrating an indirect time-of-flight (iToF) imaging system using a target at a set distance from the iToF imaging system, comprising:
applying, by a camera module of the iToF imaging system, a delay to an illumination modulation signal or a pixel modulation signal, wherein the delay corresponds to a distance offset from the set distance;
transmitting, by the iToF imaging system, a light signal according to the illumination modulation signal;
receiving, at a pixel array of the camera module, a reflected signal comprising the light signal reflected from the target;
generating, by the pixel array, a pixel response based the reflected signal and the pixel modulation signal;
determining, by the camera module, a distance-related value based on the pixel response;
determining, by the camera module, a correction value based on a difference between the determined distance-related value and an expected distance-related value due to the applied delay; and
storing, in a memory of the camera module, the correction value associated with the distance-related value.

2. The method of claim 1, further comprising:
performing the steps of applying, transmitting, receiving, generating, determining the distance-related value, determining the correction value, and storing for each of a plurality of applied delays to create a corresponding plurality of stored correction values.

3. The method of claim 2, wherein the target has a shape, and wherein the method further comprises:
measuring the shape of the target by performing, using the iToF imaging system, a plurality of depth measurements of the target, wherein each of the depth measurements is corrected using a corresponding one of the plurality of stored correction values; and
determining whether the measured shape of the target is within a threshold of a first shape.

4. The method of claim 2, wherein:
the pixel array comprises a plurality of column slices; and
the pixel response for each of the column slices is based on a pixel modulation signal having a constant delay from adjacent column slices.

5. The method of claim 1, wherein the memory is included in a sensor module of the camera module and comprises a look-up table (LUT).

6. The method of claim 5, wherein the distance-related value is calculated by a phase calculation circuitry of the sensor module.

7. The method of claim 1, wherein the delay is applied by a delay generator.

8. The method of claim 1, wherein the distance-related value is a phase offset or a depth measurement.

9. The method of claim 1, wherein:
the distance-related value comprises a depth measurement;
determining the distance-related value comprises:
calculating a phase offset based on the pixel response; and
calculating the distance-related value based on the calculated phase offset; and
the correction value comprises a distance information.

10. An indirect time-of-flight (iToF) imaging system, comprising:
a modulation delay generator configured to generate a pixel modulation signal having a delay;
a pixel array configured to output a pixel response signal;
a modulation controller configured to control the pixel array according to the pixel modulation signal;
a phase calculation circuitry configured to determine a correction value based on the pixel response signal; and
a memory storing a look-up table for a plurality of correction values.

11. The iToF imaging system of claim 10, further comprising a sensor module, wherein the sensor module comprises the pixel array, the modulation controller, the phase calculation circuitry, and the memory.

12. The iToF imaging system of claim 10, wherein the phase calculation circuitry is configured to:
determine the correction value based on a difference between a calculated distance-related value for the pixel response signal and an expected distance-related value due to the delay of the pixel modulation signal; and
wherein the memory is further configured to store the correction value.

13. The iToF imaging system of claim 12, wherein the distance-related value is a phase offset or a depth measurement.

14. The iToF imaging system of claim 12, wherein the phase calculation circuitry is further configured to:
calculate a second distance-related value based on a second pixel response signal output by the pixel array during a non-calibration operation of the iToF imaging system;
obtain, from the look-up table, one of the plurality of stored correction values based on the second distance-related value; and
determine a corrected depth value based on the obtained correction value.

15. The iToF imaging system of claim 10, further comprising:
an emitter delay generator configured to generate an illumination modulation signal having a second delay; and
a laser controller configured to control an emitter to produce a light signal according to the delayed illumination modulation signal.

16. The iToF imaging system of claim 10, wherein:
the pixel array comprises a plurality of column slices; and
the modulation controller is configured to control each column slice using the pixel modulation plus an added constant delay for each subsequent column slice.

17. A method for calibrating an indirect time-of-flight (iToF) imaging system using a target at a set distance from the iToF imaging system, comprising:
receiving, by a sensor module of the iToF imaging system, a light signal from the target;
generating, by the sensor module, a plurality of pixel responses based on the received light signal and a plurality of pixel modulation signals, wherein each of the plurality of pixel modulation signals is delayed by an amount equal to a plurality of distance offsets from the set distance;
determining, by the sensor module, a plurality of distance-related values based on the plurality of generated pixel responses;
determining, by the sensor module, a plurality of correction values corresponding to the plurality of distance-related values;
storing, in a memory of the sensor module, the plurality of correction values associated with the plurality of distance-related values; and
validating, by the iToF imaging system, the plurality of correction values.

18. The method of claim 17, wherein the target has a shape, and wherein validating the plurality of correction values comprises:
measuring the shape of the target by performing, using the iToF imaging system, a plurality of depth measurements of the target, wherein each of the depth measurements is corrected using a corresponding correction value stored in the memory; and
determining whether the measured shape of the target is within a threshold of a first shape.

19. The method of claim 18, wherein:
the first shape is a flat surface; and
determining whether the measured shape of the target is within a threshold of the first shape comprises determining a flatness of the target.

20. The method of claim 18, wherein:
the sensor module includes a pixel array configured with a plurality of column slices;
each of the column slices is used to measure the shape of the target using a pixel modulation signal having a constant delay from adjacent column slices; and
correcting the depth measurements includes shifting the depth measurements by the corresponding constant delay for each column slice.
